(19) United States
(12) Patent Application Publication
(10) Pub. No.: US 2019/0035286 A1
(43) Pub. Date: Jan. 31, 2019

(54) AIRPLANE FLIGHT PATH PLANNING METHOD AND DEVICE BASED ON THE PIGEON-INSPIRED OPTIMIZATION

(71) Applicant: BEIHANG UNIVERSITY, Beijing (CN)

(72) Inventors: Xianbin Cao, Beijing (CN); Wenbo Du, Beijing (CN); Haichao An, Beijing (CN); Yumeng Li, Beijing (CN)

(21) Appl. No.: 16/048,206

(22) Filed: Jul. 27, 2018

(30) Foreign Application Priority Data
Jul. 27, 2017 (CN) 201710625878.8

(51) Int. Cl. G08G 5/00; G06Q 10/04; B64C 39/02

(52) U.S. Cl. CPC G08G 5/0034; G08G 5/0069; B64C 2201/141; B64C 39/024; G06Q 10/047

(57) ABSTRACT

An airplane flight path planning method based on the pigeon-inspired optimization algorithm includes steps of establishing an uncertainty track prediction model, determining the path to be optimized within the specified area, and obtaining an optimal path using the pigeon-inspired optimization algorithm. The pigeon-inspired optimization algorithm uses map and compass operators and performs landmark operations to obtain the optimal path. The device that performs the path planning includes an access module for getting the regional path information; a building module for setting up the trajectory prediction model including uncertainties; a determining module, which utilizes the regional path information and the trajectory prediction model to determine the trajectories which need optimization; and an optimization module, which uses the pigeon-inspired optimization algorithm to optimize the trajectories.

### CROSS REFERENCE TO RELATED APPLICATIONS

This application claims priority of China Patent Application No. 201710625878.8 filed Jul. 27, 2017, the entirety of which is incorporated herein by reference.

### BACKGROUND OF THE INVENTION

### Technical Field

The invention relates to airplane flight path planning and to multiple attribute decision making technology. More specifically, the invention relates to a flight path planning method and device based on the pigeon-inspired Optimization method.

### Description of the Related Art

Path planning is the process of determining a collision-free pathway between the current position of an unmanned aerial vehicle (“UAV”) and its destination. Researchers have been studying how to generate collision-free paths for vehicles in obstacle environments, which is critical for autonomous vehicles.

According to certain evaluation standard systems, path planning is: within a given planning space, finding the optimal and feasible flight path of the body movement from the starting point to the target point while satisfying certain constraint conditions and a certain performance index such that the movement of body safely accomplishes a predetermined task. Due to the movement of the aircraft, airplane flight path planning is complex under the complicated environment of the task. The path planning system needs to comprehensively consider the aircraft maneuverability, task time and terrain factors such as environment and enemy control area. Mathematically speaking, the aim of path planning is to find the optimal solution under many constraints.

The multi-objective optimization problem (MOP) brings multiple conflicting objectives. The essential difference between MOP and a single objective optimization problem is that in most cases of MOP, the improvement of an objective may negatively influence other objectives. Achieving the best performance of all the multiple objectives at the same time is impossible, as the optimum can only be achieved by proper coordination and compromising between the objective functions as far as possible.

The present existing aircraft flight path planning technology does not consider uncertainty conditions, such as wind, angle change, starting and end points of the operation, etc., resulting in a poor stability of the path planning procedure. With a slight deviation, path planning might not be easily adapted, and path replanning could lead to unnecessary time consumption.

Pigeon-inspired optimization (“PIO”) algorithm was first proposed by Prof. Duan Haibin in 2014 . The PIO algorithm, compared to other bionic intelligent optimization algorithms, possesses parallelism in searching process, feasibility and characteristics of strong robustness, so it can be used to solve complex optimization problems in succession.

PIO is a novel swam intelligence optimizer for solving global optimization problems. It is based on the natural behavior of pigeons. The migration of pigeons is described with two mathematical models. One is a map and compass operator, and the other one is a landmark operator.

Since the discovery of small-world phenomenon by Watts and Strogatz and scale-free property by Baraba'si and Albert a decade ago, it has been realized that most real networks are neither fully connected networks nor homogeneous regular networks, but of small-world and scale-free topological characteristics. In this paper, the pigeon-inspired optimization algorithm considers the topological characteristics. Much evidence has demonstrated that the structural properties play key roles in dynamical processes taking place on complex networks. Previous findings prompt us to wonder how scale-free topology that captures the interaction pattern among pigeons affects the PIO and if scale-free topology can offer better performance of the optimization process. To answer these questions, the present invention has incorporated scale-free topology into the pigeon-inspired optimization in an attempt to improve the optimization process with respect to its solution quality and convergence velocity. We have found that the scale-free topology that captures the diversity of individuals leads to the balance between the solution quality and the convergence efficiency, which outperforms the traditional pigeons optimization algorithm based on either fully-connected graph or regular graph.

### BRIEF SUMMARY OF THE INVENTION

The purpose of the present invention is to provide a flight path planning method and device based on an intelligent optimization algorithm, especially considering the uncertainty of the route optimization problem. Compared with the ordinary path planning problem, the present invention takes into account the influence of the uncertainty so as to achieve a higher path stability.

The purpose of the present invention is to provide the flight path planning method and device based on an intelligent optimization algorithm, Firstly, an uncertainty track prediction model is established, followed by determination of the path to be optimized within the specified area. Finally, by using a path optimization algorithm, an optimal path is obtained.

The steps of establishing the uncertainty track prediction model are described in the following section.

Suppose there are K number of points that can change the course angle between the starting point and destination point within a specific area, the change of course angle is expressed by θ₁, θ₂, . . . , θ_{K}, then the whole flight trajectory consists of K+1 path sections, with their lengths defined as d₀, d₁, . . . , d_{K}, so the aircraft trajectory path function is described by:

$${f}_{L} = {( {\sum }_{k = 0}^{K} {d}_{k} )}^{2}$$

With m threat centers within the region, the aircraft navigation path points are represented by p₀, p₁, . . . , pₙ, pₙ₊₁, with p₀, pₙ₊₁ as starting and destination points respectively of the flight trajectory. As shown in FIG. 2. Each path point has an elliptical convex hull (“ellipse”) describing the position uncertainty of the aircraft. The cost f_{TA} of the aircraft's navigation path caused by the threat centers is defined as

$${f}_{TA} = {\sum }_{i = 1}^{n} {\sum }_{j = 1}^{m} \frac{1}{{( {r}_{ij} \text{/} {r}_{safe} )}^{2}}$$

where, rᵢⱼ represents the shortest distance between a path point ellipse and the threat center j and r_{safe} denotes the safe distance of the threat center.

The track prediction model including uncertainty is described as follows:

min f_{cost}=wf_{L}+(1−w)f_{TA}

where w is the weight coefficient.

The constraint conditions are as follows: the value of each course angle change θ₁, θ₂, . . . , θ_{K-1} have a set range; the minimum value of each path length is the step length L, the maximum is the set upper limit; d₀, d₁, . . . , d_{K-1}, θ₁, θ₂, . . . , θ_{K-1} cannot be 0; rᵢⱼ≥r_{safe}.

According to the established track prediction model, an optimal path is obtained by using a intelligent optimization algorithm, followed by the output d₀, d₁, . . . , d_{K-1}, θ₁, θ₂, . . . , θ_{K-1}.

The present invention provides the aircraft track planning device, which, as shown in FIG. 7, includes:

(a) an access module for getting the regional path information;

(b) a building module having one or more building blocks for setting up the trajectory prediction model including uncertainties;

(c) a determining module, which utilizes the regional path information and the trajectory prediction model to determine the trajectories which need optimization;

(d) an optimization module, which uses the pigeon-inspired optimization algorithm to optimize the trajectories; and

(e) a storage module for storing the parameters of the optimal path.

The advantages of the invention are the ability to consider uncertainties during route optimization procedures and its robustness and feasibility.

Track prediction model calculation is also an innovative feature of the present invention.

The much better performance of the invention is attributed to the cooperation between hub nodes and non-hub nodes, where the former is of strong ability to ensure high solution quality and guides the evolution direction, while the latter helps maintain the activity of the population for exploring the solution space and escaping from local optima. The invention suggests the paramount importance of exploiting the diversity in population for achieving better evolution pattern of pigeons, which has many implications in computational intelligence and controlling a variety of dynamical processes. The invention proposes a method, in which scale-free network that incorporates the diversity of individuals is exploited to better mimic the real situation and improve the traditional PIO.

### BRIEF DESCRIPTION OF THE DRAWINGS

FIG. 1 is a schematic diagram of a track operation for changing route angles to avoid a threat;

FIG. 2 illustrates track diagram taking uncertainty into consideration;

FIG. 3 shows the implementation steps of airplane flight path planning according to the present invention;

FIG. 4 illustrates the map compass model of the PIO algorithm;

FIG. 5 illustrates the landmark model of the PIO algorithm;

FIG. 6 illustrates the improved PIO algorithm;

FIG. 7 shows a schematic diagram of the device for path planning according to the present invention; and

FIG. 8 illustrates a simplified block diagram of an airplane flight path planning system.

### DETAILED DESCRIPTION OF THE PREFERRED EMBODIMENTS

The invention will now be further described using the accompanying drawings and examples.

According to the track trajectory model, the prediction of the next flight moves takes different sources of uncertainty into account, such as wind, course angle change, operation starting and end points, etc. Afterwards, a pigeon-inspired optimization (“PIO”) algorithm is used to generate an optimal path.

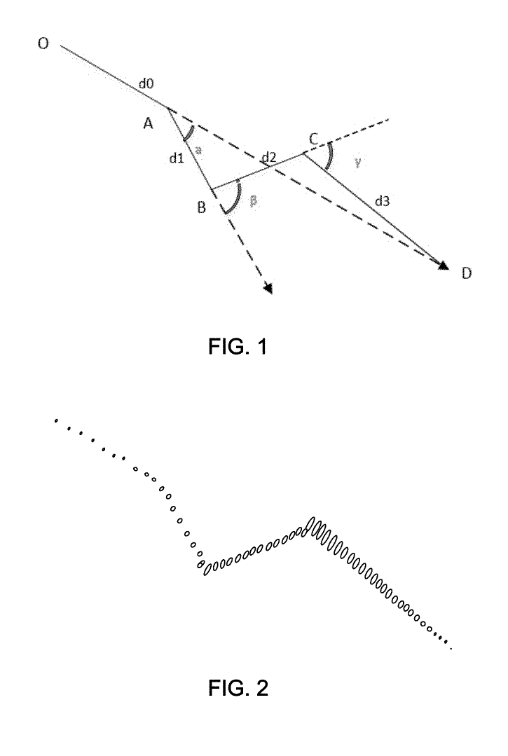

In order to limit the search space to a reasonable area, the course angle within the trajectory model of the invention is limited to three changes from the starting point to the end point. However, this is for the purpose of illustrating the algorithm, and the algorithm is not limited to three course angle changes along the flight path. As shown in FIG. 1, the first step of the flight operation changes the course angle by an angle a while the distance parameter d₀ has a distance uncertainty ε₀, which means that the plane may be in a range of ±ε₀ from d₀ to start the operation. Furthermore, the parameter Eₐ represents an uncertainty of the flight path course angle α. During the second step, the flight path is changed by the angle β after traveling the distance d₁ with flight path course angle and distance uncertainties ε_{β}, ε₁; After flying d₂, the flight path angle is changed according to the heading angle towards the destination point with existing distance uncertainty ε₂.

As seen in FIG. 1, O marks the starting point, D the destination point, while A, B, and C show the positions of the course angle changes. The coordinates of the starting point are (x₀, y₀) and the coordinates of the destination point are (x₄, y₄). The remaining coordinates of the path angle changes at A, B, and C are (x₁, y₁), (x₂, y₂), and (x₃, y₃), respectively. The course angle changes at point A and point B are α and β.

The variables d₀, d₁ , d₂, α, β with their corresponding uncertainty parameters ε₀, ε₁, ε₂, ε_{β} have the upper limit of d₀ₘₐₓ, d₁ₘₐₓ, d₂ₘₐₓ, αₘₐₓ, βₘₐₓ, respectively. The shortest distance from the starting point to the destination point is defined as dₘᵢₙ. With m threat centers within the region, the aircraft navigation path points are represented by p₀, p₁, . . . , pₙ, pₙ₊₁, with p₀, pₙ₊₁ being the starting and destination points respectively of the aircraft navigation path. Each path point has an elliptical convex hull describing the position uncertainty of the aircraft.

The following section covers the process of obtaining the equation which describes the uncertainty track prediction model:

Utilizing the coordinates of the starting and end points yields

$$( \frac{{y}_{4} - {y}_{0}}{{x}_{4} - {x}_{0}} ) ( x - {x}_{0} ) = y - {y}_{0}$$

the slope of line OD:

$${k}_{1} = \frac{{y}_{4} - {y}_{0}}{{x}_{4} - {x}_{0}} = tan γ$$

The coordinates of point A (x₁, y₁) are given by

$$( \frac{{d}_{0}}{\sqrt{{k}_{1}^{2} + 1}} + {x}_{0} , {k}_{1} ( {x}_{1} - {x}_{0} ) + {y}_{0} )$$

the slope of line AB: k₂=tan (α+γ)

The coordinates of point B (x₂, y₂) are given by

$$( \frac{{d}_{1}}{\sqrt{{k}_{2}^{2} + 1}} + {x}_{1} , {k}_{2} ( {x}_{2} - {x}_{1} ) + {y}_{1} )$$

the slope of line BC: k₃=tan (α+β+γ)

The coordinates of point C (x₃, y₃) are given by

$$( \frac{{d}_{2}}{\sqrt{{k}_{3}^{2} + 1}} + {x}_{2} , {k}_{3} ( {x}_{3} - {x}_{2} ) + {y}_{2} )$$

The distance d₃ between point C and the destination point is given by

d₃=\sqrt{(x₄−x₃)²+(y₄−y₃)²}

The aircraft trajectory path function f_{L} and the cost f_{TA} of the aircraft's navigation path caused by the threat centers are defined as

f_{L}=(d₀+d₁+d₂+d₃)²;

$${f}_{TA} = {\sum }_{i = 1}^{n} {\sum }_{j = 1}^{m} \frac{1}{{( {r}_{ij} \text{/} {r}_{safe} )}^{2}}$$

According to these four functions, we build a fitness function:

min f_{cost}=wf_{L}+(1−w)f_{TA}

Constraint conditions are as follows:

$$- {α}_{max} \leq α \leq {α}_{max} , {α}_{max} = \frac{π}{6} ; \\ - {β}_{max} \leq β \leq {β}_{max} , {β}_{max} = \frac{π}{6} ;$$

$$L \leq {d}_{0} \leq {d}_{0 max} , L \leq {d}_{1} \leq {d}_{1 max} , L \leq {d}_{2} \leq {d}_{2 max} ;$$

$${d}_{0} , {d}_{1} , {d}_{2} , α , β all are nonzero ;$$

$${r}_{ij} \geq {r}_{safe} .$$

The weight coefficient w ranges from 0 to 1 and the minimum step size L changes the flight route around a corner using the shortest way possible.

As shown in FIG. 2, Each path point has an elliptical convex hull describing the position uncertainty of the aircraft.

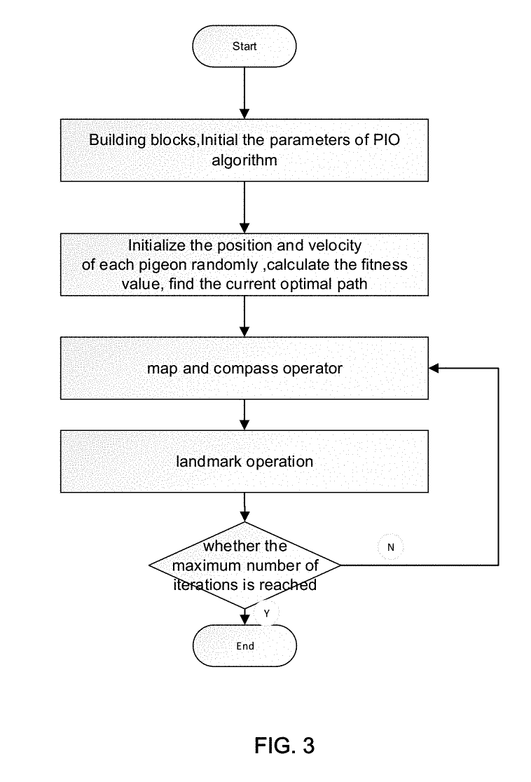

The method for planning a flight path of an aircraft based on the pigeon-inspired optimization algorithm of the present invention may include the steps as shown in FIG. 3 as a whole as follows:

Step 1: establish trajectory prediction model with uncertainty;

Step 2: initialize the route to be optimized by the pigeon-inspired algorithm according to the route information in the specified area, and initialize the parameters such as the dimension D of the search space, pigeon population, iteration number, and geomagnetic factor R in the pigeon-inspired optimization algorithm;

Step 3: set the speed and position of each pigeon at random, calculate the fitness value according to the fitness function, find the current optimal path, and store each parameter of the current optimal path: α, β, d₀, d₁, d₂. The current optimal path corresponds to the largest fitness value.

With the trajectory prediction model above, the present invention is to solve the minimization problem, for which the objective function is expressed as

$$f ( X ) = \frac{1}{{f}_{min} ( X ) + ɛ} ,$$

where fₘᵢₙ(X) is the fitness function min f_{cost}=wf_{L}+(1−w)f_{TA}, and X stands for a particular path.

Step 4: apply map and compass operator to update the speed and position of each pigeon;

Step 5: perform landmark operations, sort all pigeons according to fitness values, lower-adapted pigeons follow the adapted pigeons and find the center of the flock (destination), all pigeons will fly directly to their destination.

Calculate the fitness value of each path, update the various parameters of the current optimal path: α, β, d₀, d₁, d₂.

Step 6: Determine whether the maximum number of iterations is reached, and if not, continue to Step 4 and repeat the operation of map and compass and landmark until the number of iterations reaches the maximum number of iterations of landmark operator.

The Map and compass operator in Step 4 above is further described below.

In the PIO model, virtual pigeons are used. In the map and compass operator, the rules are defined with the position Xᵢ and the velocity Vᵢ of pigeon i, and the position and velocity in a D-dimension search space are updated in each iteration. In D dimension of search space, denote the position and velocity of the i-th pigeon as:

Xᵢ=(Xᵢ₁, Xᵢ₂, . . . , X_{iD}) Vᵢ=(Vᵢ₁, Vᵢ₂, . . . , V_{iD})

The new position and velocity of pigeon i at the t-th iteration can be calculated with the following equations:

Vᵢ^{t}=Vᵢ^{t-1}e^{-Rt}+r₁(X_{g}−Xᵢ^{t-1})

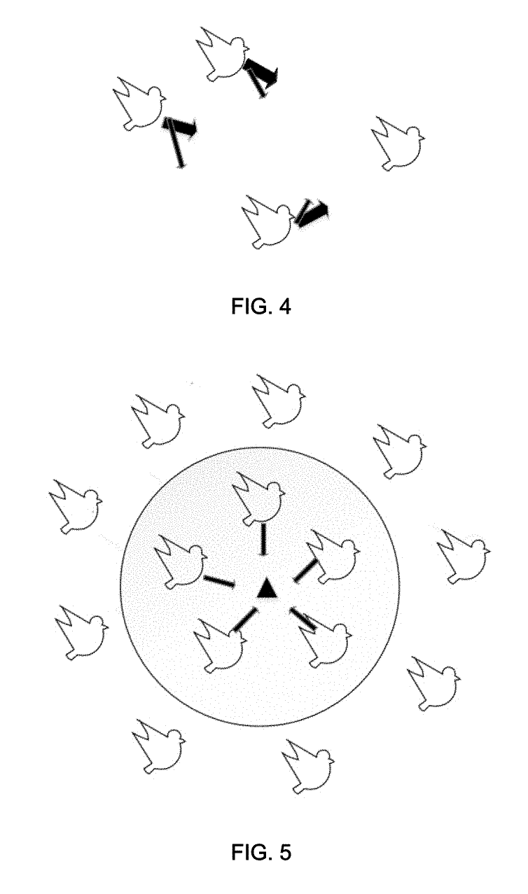

Xᵢ^{t}=Xᵢ^{t-1}+Vᵢ^{t}

where R is the map and compass factor, r₁ is a random number ranging from 0 to 1 and X_{g} is the current global best position, which can be obtained by comparing all the positions of the pigeons. The operator model is shown in FIG. 4. As is shown in FIG. 4, the pigeon on the right side of the figure is the one with the best position. The thin arrows are their previous flying directions, while the thick ones are the directions that they adjust to according to the best one. The sum of the velocities is their current directions.

As shown in FIG. 4, the right-centered pigeon (global best position), pointed by thick arrows from other pigeons, can be seen as a compass-direction which can lead the other pigeons directly to better orientations. Meanwhile, each pigeon has its own map-direction (the thin arrow) , and the final direction for every single pigeon is the vector sum of the map-direction and compass-direction.

The landmark operation in Step 5 above is further described below.

In the landmark operation, as shown in FIG. 5, half of the number of pigeons is decreased by Nₚ in every generation. However, the pigeons are still far from the destination point, and they are unfamiliar with the landmarks. Let X_{c}^{t} be the center of some pigeons' position at the t-th iteration, and suppose every pigeon can fly straight to the destination point. The position updating rule for pigeon i at t-th iteration can be given by:

$${N}_{p}^{t} = c \cdot {N}_{p max}$$

$${X}_{c}^{t} = \frac{{\sum }_{{N}_{p}} {X}_{i}^{t} f ( {X}_{i}^{t} )}{{\sum }_{{N}_{p}} f ( {X}_{i}^{t} )}$$

$${X}_{i}^{t} = {X}_{i}^{t - 1} + {r}_{2} q ( {X}_{c}^{t} - {X}_{i}^{t - 1} )$$

where fitness value is the quality of the individual pigeon. For the minimization problem, the objective function is expressed as

$$f ( X ) = \frac{1}{{f}_{min} ( X ) + ɛ} ,$$

where ε is a given small number to avoid the value of the denominator being zero.

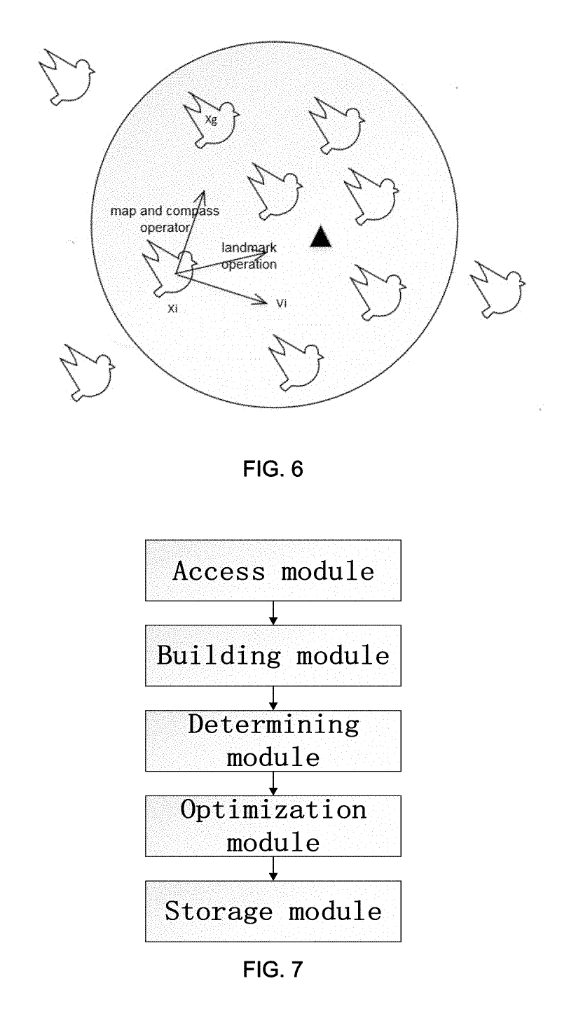

As shown in FIG. 6, the pigeon algorithm model adopted by the present invention iterates to obtain the optimal path through the map and compass operation and landmark operation, and finally outputs the obtained various parameters of the optimal path.

Correspondingly, the aircraft track planning device based on the pigeon-inspired optimization algorithm provided by the present invention, as shown in FIG. 7, comprises an access module, a building module, a determining module, an optimizing module and a storage module. The following describes each module.

The access module is used to obtain the path information in the specified area, mainly including the starting point and destination point in the specified area, the obstacle information and the like.

The building module having one or more building blocks is used to build trajectory prediction models that contain uncertainty. The process of building a trajectory prediction model is not repeated here.

The determining module is configured to determine a path to be optimized according to the path information and the trajectory prediction model.

The optimization module is used for optimizing the route to be optimized by the pigeon-inspired optimization algorithm. The pigeon-inspired optimization algorithm, shown in FIGS. 4-6, is used to optimize the path to be optimized and obtain the optimal path.

The storage module is used to store the parameters of the optimal path. The parameters include the positions at which the heading angle is changed between the starting point and the destination point as well as the changed angles.

### Airplane Path Planning System

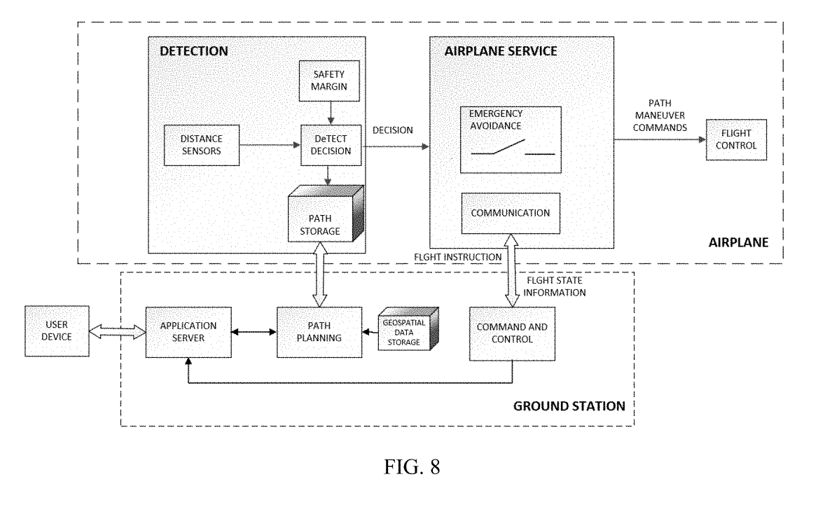

To facilitate understanding of a complete process of airplane path planning, this invention describes an airplane path planning system. FIG. 8 illustrates a simplified block diagram of an airplane path planning system. This system includes a detection module coupled to an airplane service module that is in communication with a ground station module, an user device module and a flight control module.

The detection module includes a distance sensor module, a safety margin module, a detect decision module and a path storage module. The distance sensor module on board the airplane is applied to measure the distance between the airplane and obstacles, and deliver sensing data to the detect decision module for making decisions. Examples of sensors available on board the airplane are ultrasonic radar, infrared radar, and optical sensors. Moreover, the sensing range of the sensor module may vary. The path storage module stores the information, i.e. the determined path, which is generated by the path planning module. In this invention, a safety margin module that is directly related to the airplane flight speed is designed to restrict the safety distance between the airplane and obstacles in the flying direction of the airplane. For example, if the distance between the airplane and obstacles in the flying path is less than the safety margin, the airplane is considered to hit these obstacles; otherwise, the airplane will not hit the obstacles. The detect decision module makes decisions based on an integrated information that are provided by the distance sensor module, safety margin module and path storage module respectively.

The ground station module includes a path planning module, an application server module, a geospatial data storage module, and a command control module. The path planning module is responsible for planning a path for the airplane before take-off or before a change of the mission and delivers the path to the path storage module. The path planning module is based on the Pigeon-Inspired Optimization method to plan the path. Further details regarding the path determination algorithm are described with respect to the path planning module. If the user device has been authenticated by the application server module, the path planning module sends the determined path to it. The geospatial data storage module is a spatial database that includes latitude and longitude data, which delivers the data to the path planning module. Example data and data sources for the geospatial data storage include, but are not limited to, terrain data from the National Aeronautics and Space Administration (NASA), airspace data from the Federal Aviation Administration (FAA), geospatial data from the National Park Service and other federal agencies, geospatial and building data from local agencies such as school districts and some combination thereof. The geospatial data storage module may include large amounts of data such as hundreds of gigabytes or terabytes of data. The application server module authenticates the user device module and is responsible for information feedback. Feedback contains two aspects, one of which is the path planning module transmitting the determined path to the user device module through the application server module, the second one being the command and control module transmitting flight plans and instructions to the application server module.

First, the user device module receives a path request containing an origin location and a destination location for the airplane, followed by the previously mentioned authentication, authorization and information feedback processes. The role of the command and control module is to communicate with the airplane. For example, the command and control module would send control instruction to the airplane and accept airplane state information from the airplane. For example, if the status information of the aircraft shows a non-normal status, such as a low fuel level, the aircraft informs the command control module of the situation via the communication module. Afterwards, the command control module sends return commands to the aircraft and to the user module through the application module simultaneously, the user module display anomalies, and ground station stop path planning. As an example, a process consists of a user system which receives a path request, containing a starting location and a destination location for an airplane. The path request may be input by a user device. A starting point at a particular location is selected by the user from the user interface of the user device module. The process also includes receiving geo-spatial information associated with the starting location and the destination location, with the geo-spatial information containing at least one physical obstacle and a no-fly zone, while respecting airspace regulations and being energy-efficient. It is possible to receive the geo-spatial information from a remote location, e.g. a server or cloud application service in communication with the user device.

The airplane service module includes a communication module and an emergency avoidance module. The communication module communicates with the ground station and is reserved as an operator interface to accept control and management commands from the ground station. Once the emergency avoidance module receives a path-planning-decision from the detection module, the module either keeps flying on the original path or begins planning an updated trajectory avoiding dynamic obstacles using an independent obstacle avoidance function before changing back to the original path leading to the destination point. If there is no dynamic obstacle encountered during the flight, the emergency avoidance module is not activated. The airplane service module passes path maneuver commands to the flight control module. The flight control module is responsible for controlling critical parameters such as height, speed, angle, and attitude of the airplane, securing stable flight.

The airplane can be configured to communicate wirelessly with the ground station. Wireless communication uses one or more networks of any suitable communication medium, including GSM, GPRS, CDMA, WIFI, satellite, radio, RF, radio modems, ZigBee, XBee, XRF, XTend, Bluetooth, WPAN, line of sight, satellite relay, or any other wireless data links.

The present invention takes into account the influence of uncertainty. Compared with the existing method, the obtained route possesses good stability, certain robustness and feasibility.

What is claimed is:

1. An aircraft flight path planning method, comprising the steps of:
(a) providing a computer-based system including an access module, a building module, a determining module and an optimization module;
(b) the access module obtaining regional path information in a given specific area, including information on a starting point, a destination point, and obstacles in the specific area;
(c) the building module establishing an uncertainty track prediction model;
(d) based on the regional path information and the uncertainty track prediction model, the determining module determining a flight path to be optimized within the specific area; and
(e) the optimization module applying a pigeon-inspired optimization algorithm to obtain an optimal path by using a pigeon-inspired optimization algorithm to optimize the flight path determined in step (d), wherein
the uncertainty track prediction model in step (c) is formulated as:
$$min {f}_{cost} = {wf}_{L} + ( 1 - w ) {f}_{TA} \\ where \\ {f}_{L} = {( {\sum }_{k = 0}^{K} {d}_{k} )}^{2} , \qquad ( I )$$
where K is the number of points at which an aircraft may change course angle between the starting point and the destination point within the specific area, the corresponding changes of the course angle being θ₁, θ₂, . . . , θ_{K} , respectively, so that the flight path consists of K+1 path sections with respective lengths d₀, d₁, . . . , d_{K};
$${f}_{TA} = {\sum }_{i = 1}^{n} {\sum }_{j = 1}^{m} \frac{1}{{( {r}_{ij} \text{/} {r}_{safe} )}^{2}} ,$$
where m is the number of threat centers corresponding to the obstcles within the specific area, n is the number of points along the aircraft's navigation path represented by p₀, p₁, . . . , pₙ, pₙ₊₁, with p₀, pₙ₊₁ respectively corresponding to the starting and the destination point of the flight path, wherein each of the points on the navigation path has an elliptical convex hull (“ellipse”) describing the position uncertainty of the aircraft,
rⱼᵢ represents the shortest distance between the ellipse of a point pᵢ and the threat center j, and rᵢⱼ≥r_{safe}, where r_{safe} denotes the safe distance for the threat centers;
w is a weight coefficient; and
each of the angles θ₁, θ₂, . . . , θ_{K-1} is nonzero and has a set range; each of the d₀, d₁, . . . , d_{K-1} is positive and has a set range; and
wherein the pigeon-inspired algorithm in step (e) yields the values of d₀, d₁, . . . , θ₁, θ₂, . . . , θ_{K-1} for the optimal path.

2. The aircraft flight path planning method as claimed in claim 1, wherein
K=3;
each of the angles θ₁, θ₂, . . . , θ_{K} is constrained between −π/6 and π/6; and
each of d₀, d₁, . . . , d_{K-1} has a minimum step size L.

3. The aircraft flight path planning method as claimed in claim 1, wherein the pigeon-inspired optimization algorithm is used to minimize the value of:
$$f ( X ) = \frac{1}{{f}_{min} ( X ) + ɛ}$$
wherein fₘᵢₙ(X) is the function in formula (I), ε is a given small positive number, and X stands for a particular flight path.
